(19) United States
(12) Patent Application Publication
(10) Pub. No.: US 2020/0092255 A1
(43) Pub. Date: Mar. 19, 2020

(54) ENHANCED COMMUNICATION OF SERVICE STATUS INFORMATION IN A COMPUTING ENVIRONMENT

(71) Applicant: VMWARE, INC., Palo Alto, CA (US)

(72) Inventors: Ravi Kumar Reddy Kottapalli, Bangalore (IN); Kannan Balasubramanian, Bangalore (IN); Srinivas Sampatkumar Hemige, Bangalore (IN); Shubham Verma, Bangalore (IN); Suket Gakhar, Palo Alto, CA (US)

(21) Appl. No.: 16/252,746

(22) Filed: Jan. 21, 2019

(30) Foreign Application Priority Data
Sep. 19, 2018 (IN) 201841035253

(51) Int. Cl. H04L 29/06; H04L 12/741; H04L 12/66

(52) U.S. Cl. CPC H04L 63/029; H04L 12/66; H04L 45/74; H04L 69/18

(57) ABSTRACT

Described herein are systems, methods, and software to improve distribution of service information in a computing environment. In one implementation, a computing element identifies a modification to a locally maintained service data structure that maintains status information for services of a computing environment. In response to the modification, the computing element may identify a key-value pair and add the key-value pair to a gateway protocol packet. Once added to the packet, the computing element may communicate the packet to a second computing element.

### RELATED APPLICATIONS

Benefit is claimed under 35 U.S.C. 119(a)-(d) to Foreign Application Serial No. 201841035253 filed in India entitled “ENHANCED COMMUNICATION OF SERVICE STATUS INFORMATION IN A COMPUTING ENVIRONMENT”, on Sep. 19, 2018, by VMware, Inc., which is herein incorporated in its entirety by reference for all purposes.

### TECHNICAL BACKGROUND

Fog computing or fog networking is a computing architecture that uses edge computing elements to provide computation, storage, and other operations for internet of things devices coupled to the edge computing elements. These internet of things devices may comprise cameras, actuators, sensors, or some other similar device that generates and receives input and output data. The edge computing elements or servers may provide computational operations on the data to limit the amount of data that is required to be transferred to another computing network or system. In particular, edge computing elements may comprise industrial controllers, switches, routers, embedded servers, processors of surveillance cameras, or some other similar device capable of providing computational resources near the internet of things devices. These edge computing elements may then communicate data to and from a centralized service or data center based on the local processing for the internet of things devices.

Although fog computing provides an efficient manner of using processing resources near internet of things devices to supplement the processing of data near the devices, managing the networks can be difficult and cumbersome for administrators of the environments. In particular, edge computing elements may be frequently added, removed, have services modified, become unavailable, or have some other similar modification. As a result, communication configurations for the various edge computing elements may require consistent modification and updates to reflect the current state of the network. In particular, when a configuration for an edge computing element occurs, the fog computing network may require efficient propagation of the configuration to other systems of the fog computing network.

### SUMMARY

The technology described herein enhances the management of a fog computing environment. In one implementation, a first computing element identifies a modification to a service data structure maintained by the first computing element, wherein the service data structure comprises service status information for a fog computing environment. The first computing element further, in response to the modification, determines a key-value pair associated with the modification, and generates a gateway protocol packet containing the key-value pair. Once generated, the first computing element communicates the gateway protocol packet to a second computing element associated with the modification.

### BRIEF DESCRIPTION OF THE DRAWINGS

FIG. 1 illustrates a computing environment for fog computing according to an implementation.

FIG. 2 illustrates an operation of a computing element to update a service data structure according to an implementation.

FIG. 3 illustrates an operation of a computing element to update a service data structure according to an implementation.

FIGS. 4A-4C illustrate an operational scenario of updating a service data structure according to an implementation.

FIGS. 5A-5C illustrate an operational scenario of updating a service data structure according to an implementation.

FIG. 6 illustrates a computing system capable updating a service data structure according to an implementation.

### DETAILED DESCRIPTION

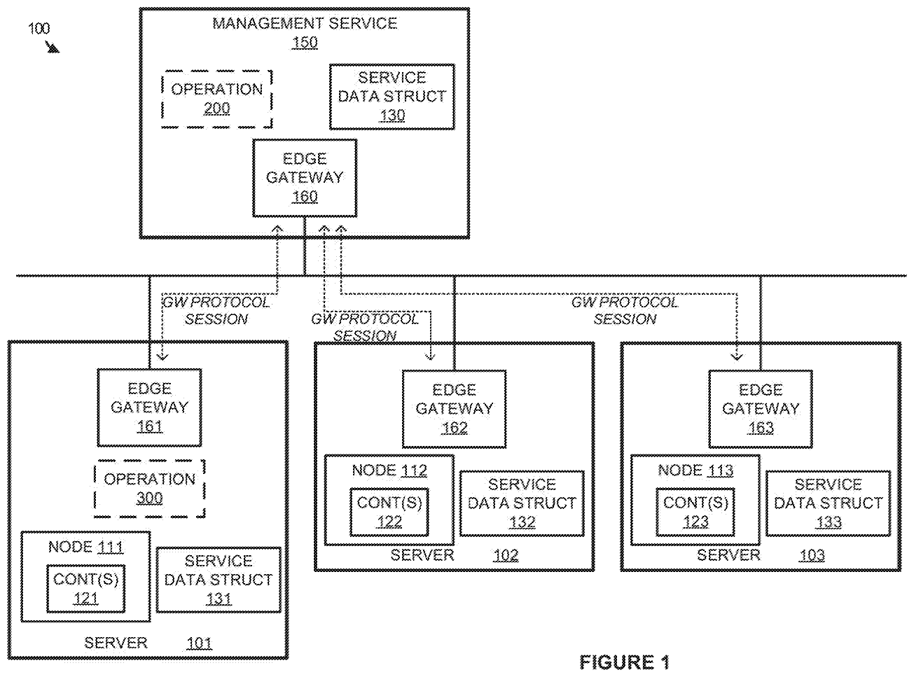

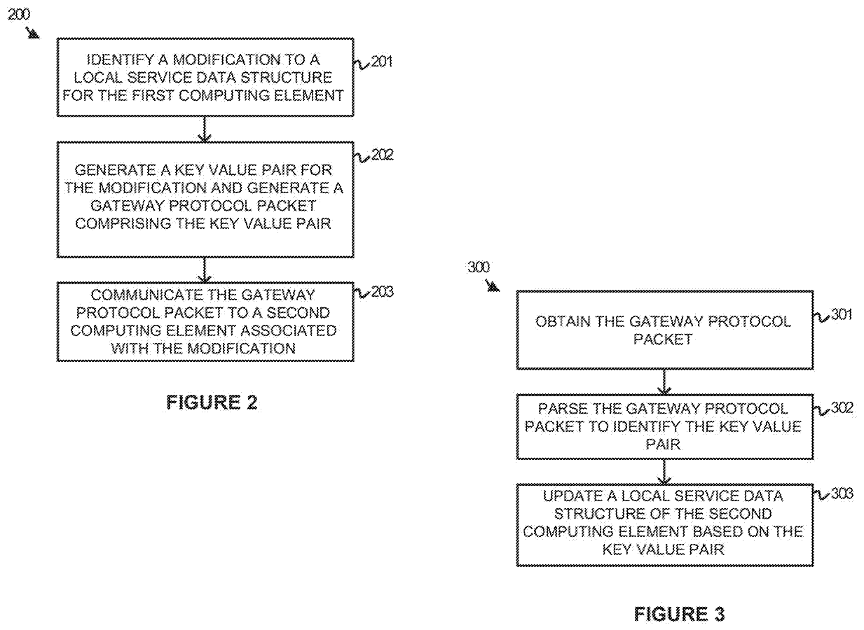

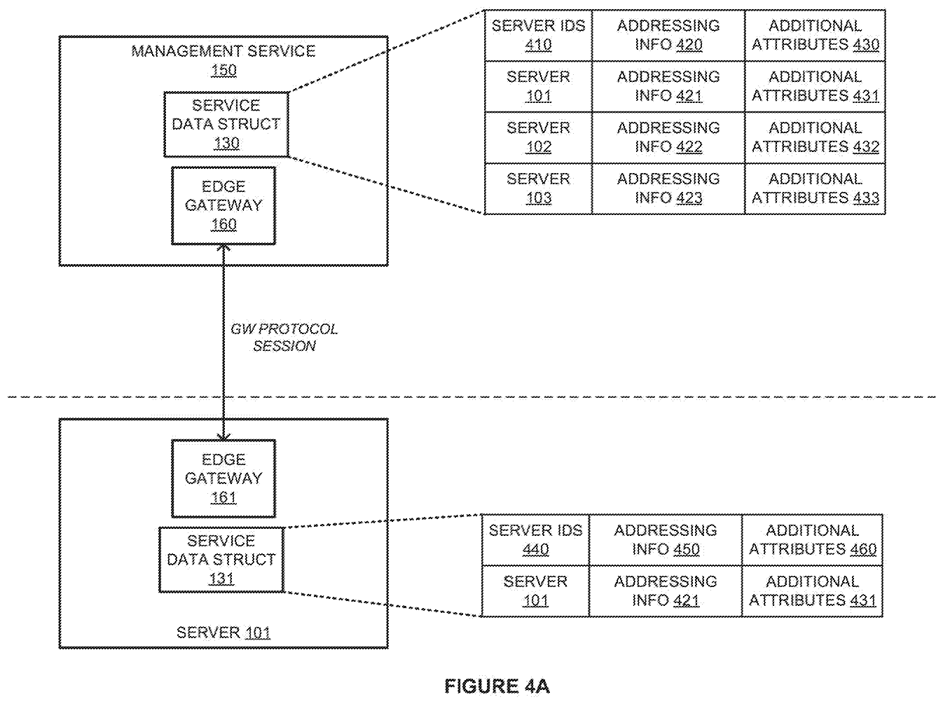

FIG. 1 illustrates a computing environment 100 for fog computing according to an implementation. Computing environment 100 includes servers 101-103 and management service 150. Servers 101-103 includes nodes 111-113, service data structures 131-133, and edge gateways 161-163. Management service 150 includes service data structure 130 and edge gateway 160. Management service 150 provides operation 200 that is further described in FIG. 2. Server 101 provides operation 300 that is further described in FIG. 3.

In operation, servers 101-103 function as fog servers that provide a platform for nodes 111-113, wherein nodes 111-113 represent virtual nodes or machines that provide computational operations near Internet of Things (IoT) edge devices (hereinafter “edge devices”) for an organization. These edge devices may comprise cameras, actuators, sensors, or some other similar device that generates and receives input and output data and may be communicatively coupled to at least one server of servers 101-13. In each of nodes 111-113, containers 121-123 execute that provide the various application and service functionality for the edge devices. Containers 121-123 may be responsible for obtaining data from the edge devices, providing data to the edge devices, processing data obtained from the devices, or some other similar operation.

Also illustrated in the example of computing environment 100 each server of servers 111-113 and management system 150 includes an edge gateway that can be used as a virtual router to communicate packets between various computing sites. This edge gateway may be logically networked to each of the nodes operating on a corresponding server of servers 101-103, and provide network communications to management service 150 and/or other computing systems required for the processing of data from the various edge devices. The edge gateways may provide network services such as static routing, virtual private networking, load balancing, firewall operations, Dynamic Host Configuration Protocol (DHCP), and network address translation. In the example of computing environment 100, each of the edge gateways establish a gateway protocol session, wherein the gateway protocol may be used by the edge gateways as a standardized exterior protocol, which is designed to exchange routing and reachability information between systems on the Internet. This edge gateway protocol may comprise a version of Border Gateway Protocol (BGP) in some examples, such as multiprotocol border gateway protocol (MP-BGP).

Once the gateway protocol sessions are established, the gateway protocol may be used by the systems of computing environment 100 to provide update information for service data structures 130-133 that correspond to addressing information for the servers 101-103, the nodes executing thereon, and the services that are provided by the nodes via containers 121-123. As an example, management server 150 may identify an addressing modification in data structure 130, wherein the modification may be monitored periodically, when the modification occurs, or at some other interval. In response to the modification, management service 150 may determine a key-value pair that indicates where the changed data is located in service data structure 130 and the value that was modified. Once the key-value pair is generated, the key-value pair may be added to at least one gateway protocol packet and communicated to the required server or servers in computing environment 100. Once received at the end server, the server may parse or process the data packet to identify the key-value pair and update the local service data structure based on the information in the key-value pair. In this manner, management service 150 and servers 101-103 may provide consistent updates to service information, including addressing, service identifiers, and usage for each of the servers that operate as part of computing environment 100. Further, the updates to the data structure may be communicated without establishing a second communication protocol session, but rather using an existing session to provide the required updates.

Although demonstrated in the example of FIG. 1 as establishing a gateway protocol session with management system 150, servers 101-103 may establish a mesh network that permits each of the servers to provide data structure updates. As an example, server 101 may identify an update to service data structure 131, wherein the update may correspond to usage information of server 101. In response to identifying the update, server 101 may communicate the update to at least one of server 102 or server 103 using a gateway protocol session established between server 102 or server 103. In communicating the update, server 101 may determine a key-value pair associated with the update and generate a gateway protocol packet that includes the key-pair. Once generated the packet may be forwarded server or servers of servers 102-103.

While not illustrated in the example of FIG. 1, it should be understood that a virtual switch may execute on servers 101-103 capable of logically connecting nodes 111-113 to a corresponding edge gateway of edge gateways 161-163. Moreover, while illustrated as separate from edge gateways 161-163, it should be understood that service data structures may be maintained at least partially by a corresponding edge gateway of edge gateways 161-163.

FIG. 2 illustrates an operation of a computing element to update a service data structure according to an implementation. The processes of operation 200 are referenced parenthetically in the paragraphs that follow with reference to systems and elements of computing environment 100 of FIG. 1.

As depicted in operation 200, a first computing element may identify (201) a modification to a local data structure. In some implementations, the data structure may be used for status information related to services provided by various nodes and servers of a computing environment. In particular, the data structure may maintain addressing information for the various servers, addressing information for the nodes executing on the servers, information about the types of services provided, information about the load on the servers or nodes, or some other similar information. In some implementations, the services provided by the servers may include fog services that are used to efficiently process data for edge devices near the edge devices reducing the quantity of data to be communicated to a centralized data processing system.

Once a modification is identified to the data structure, the at least one computing element may generate (202) a key-value pair for the modification and generate a gateway protocol packet comprising the key-value pair, wherein the key-value pair may indicate where the value is located in the data structure and the modification to the key-value pair. Once the packet is generated, operation 200 may communicate (203) the gateway protocol packet to a second computing element associated with the modification. Referring to the example, of computing environment 100 of FIG. 1, management service 150 may identify a modification to service data structure 130, wherein the modification may comprise an addressing modification for a server or a node executing thereon. The modification may be generated via an administrator of the computing environment, may be generated when a new server or node is added to the computing environment, may be modified based on the current load of a server or other computing element, or may be modified in response to any other similar operation.

Once the modification is identified, management service 150 may determine a key-value pair and include the key-value pair in a gateway protocol packet, wherein the gateway protocol session is already established between the first computing element and the second computing element. In at least one implementation, the key-value pair may correspond to a new address family type, which can be included in a MP-BGP packet. Thus, if the modification to service data structure 130 corresponded to load information for a server of servers 101-103, the key-value pair may indicate which of the values in the data structure are being modified and indicate the new value. Once generated, the key-value pair may be placed in a MP-BGP packet for communication to at least one server of servers 101-103 associated with the modification. Once placed in the packet, the packet may be communicated by edge gateway 160 to any of servers 101-103 using the established gateway protocol sessions.

Although demonstrated in the example of management service 150 with operation 200 executing outside of the edge gateway 160, operation 200 may operate wholly or partially inside edge gateway 160. Moreover, while demonstrated in the example of FIG. 1 as generating a packet that is transferred from management service 150 to a server providing fog server operations in computing environment 100, similar operations may be implemented by peer servers in the computing environment. In particular, rather than requiring a central management service, which may operate as a route reflector for the computing environment, each of the servers of the computing environment may be responsible for exchanging configuration and status information to update service data structures 131-133. As an example, server 101 may identify a modification in service data structure 131, generate the appropriate gateway protocol packet with the key-value pair, and transfer the packet to another server of servers 102-103.

FIG. 3 illustrates an operation 300 of a computing element to update a service data structure according to an implementation. The processes of operation 300 are referenced parenthetically in the paragraphs that follow with reference to element of computing environment 100 of FIG. 1.

As depicted, operation 300 includes obtaining (301) the gateway protocol packet transferred from management service 150. Once obtained, server 101 parses (302) the gateway protocol packet to identify the key value pair and updates (303) local service data structure of the second computing element based on the key-value pair. As an example, the packet from management service 150 may include a key-value pair that indicates an addressing modification for a node in computing environment. Once the packet is received, server 101 will parse or process the packet to identify the key-value pair and implement the modification in service data structure 131. Advantageously, this permits computing elements in a computing environment to exchange configuration information using an already established communication protocol session.

Although demonstrated in the example of server 101 as operating outside of edge gateway 161, operation 300 may operate wholly or partially within edge gateway 161. Additionally, while demonstrated as obtaining a packet from management service 150, server 101 may exchange data with other peer services in a computing environment in some examples. In particular, rather than relying on management service 150, which may operate as a route reflector in some examples, each server of servers 101-103 may exchange data structure information to maintain the various data structures to support the required operations. As an example, server 102 may communicate a data structure update to server 101, wherein server 101 may receive the update as a gateway protocol packet, parse the packet to identify the modification, and implement the required modification.

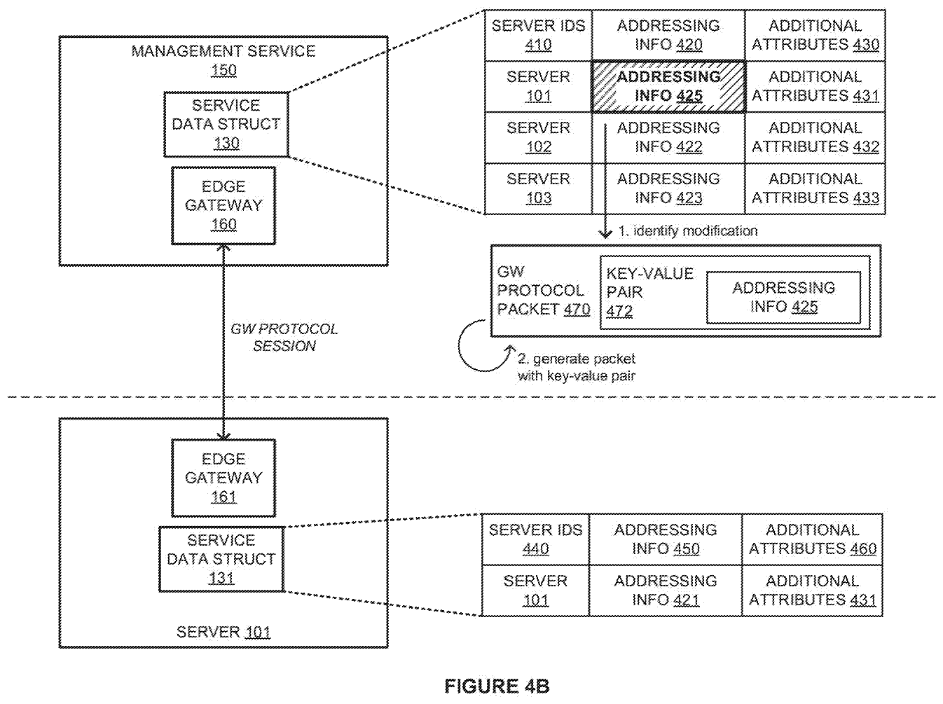

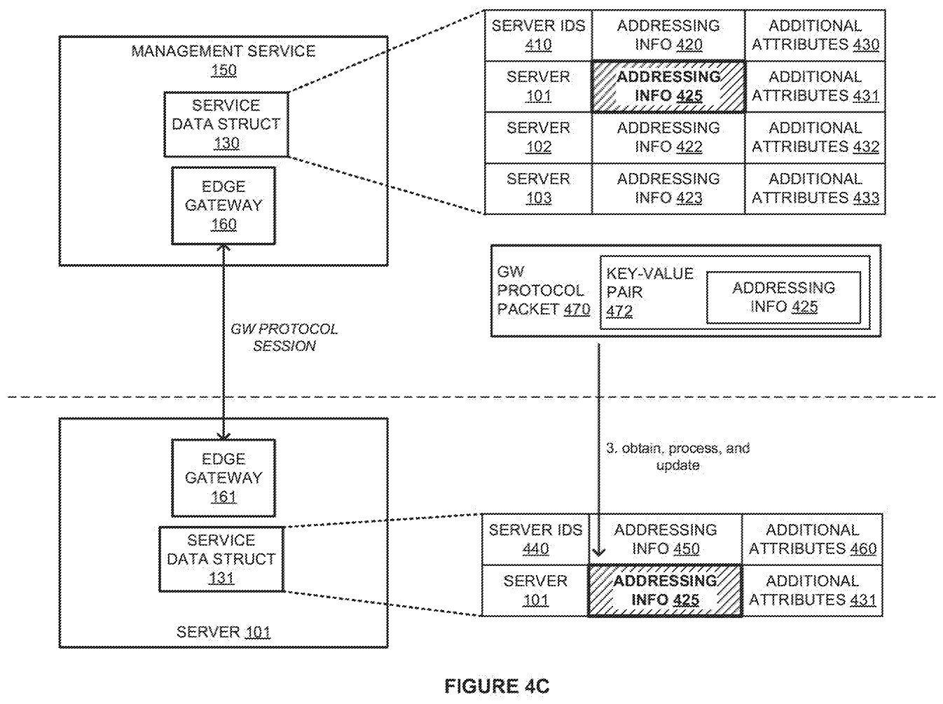

FIGS. 4A-4C illustrate an operational scenario of updating a service data structure according to an implementation. FIGS. 4A-4C include management service 150 and server 101 of FIG. 1. FIGS. 4A-4C further demonstrate an expanded example of service data structures 130-131, wherein service data structure 130 includes service identifiers (IDs) 410 with identifiers for servers 101-103, node address information 420 with addressing information 421-423, and additional attributes 430 with additional attributes 431-433. Additionally, service data structure 131 includes server IDs 440 with an identifier for server 101, addressing information 450 with addressing information 421, and additional attributes 460 with additional attributes 431. Although demonstrated with information for a single server in service data structure 131, service data structure 131 may maintain information about other servers in the network in some examples.

Referring first to FIG. 4A, management service 150 and server 101 may establish a gateway protocol session between edge gateways 160-161. This gateway protocol session is used to provide network services such as static routing, virtual private networking, load balancing, firewall operations, Dynamic Host Configuration Protocol (DHCP), and network address translation. In addition, the gateway protocol session may be used to provide updates to service data structures maintained by each of the servers in the computing environment. In particular, the service data structures maintain information about server identifiers or addresses of servers in the computing environment, addressing information for the individual virtual nodes or virtual machines that provide a platform for the services of the computing environment, as well as additional attributes for the services (or containers) executing on the nodes of the computing environment. These additional attributes may include information about the service names, service types, the load on the services, or any other similar information about the services executed on the virtual nodes. In some implementations, the services may comprise containers that execute on the host virtual nodes, wherein the virtual nodes comprise virtual machines.

Turning to FIG. 4B, management service 150 identifies, at step 1, a modification to service data structure 130, wherein the modification comprises a change of addressing information 421 to addressing information 425. In identifying the modification, management service 150 may periodically monitor service data structure 130, may identify when a modification is generated for the data structure, or may identify the modification at any other interval. The modification may be generated by an administrator of the environment, may be generated in response to the addition of a new computing element in the environment, or may be generated in any other interval. Once the modification is identified, management service 150 generates, at step 2, gateway protocol packet 470 with key-value pair 472, wherein key-value pair 472 includes addressing information 425. In particular, key-value pair 472 may identify where the modification was made in service data structure 130 and may further define the modification or new value for the data structure.

Referring to FIG. 4C, after gateway protocol packet 470 is generated, management service 150 may transfer the packet to server 101 using the gateway protocol session established between edge gateways 160 and 161. After transferring gateway protocol packet 470, server 101 obtains, at step 3, the packet, processes the packet to identify key-value pair 472, and updates service data structure 131 based on the information in the key-value pair. In particular, because addressing information 425 replaces addressing information 421, server 101 may update service data structure 131 to indicate the modification.

Although demonstrated in FIGS. 4A-4C as communicating data from management service 150 to server 101, management service 150 may distribute updates to other servers of the computing environment. In particular, in a similar manner to the transfer of gateway protocol packet 470, management service 150 may provide updates to servers 102-103 of computing environment 100 to ensure each of the service data structures in the computing environment are maintained.

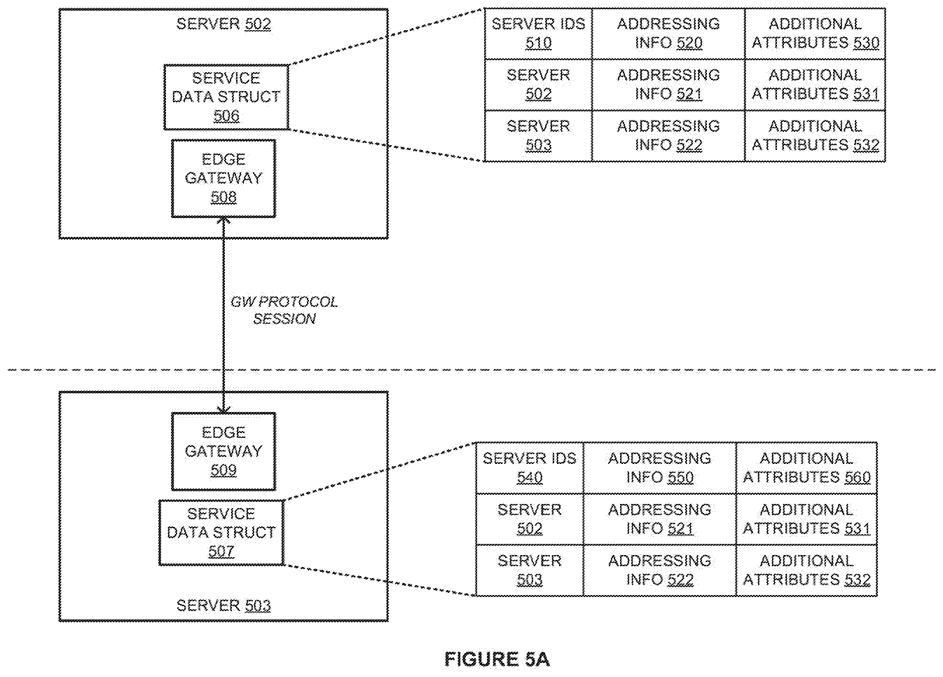

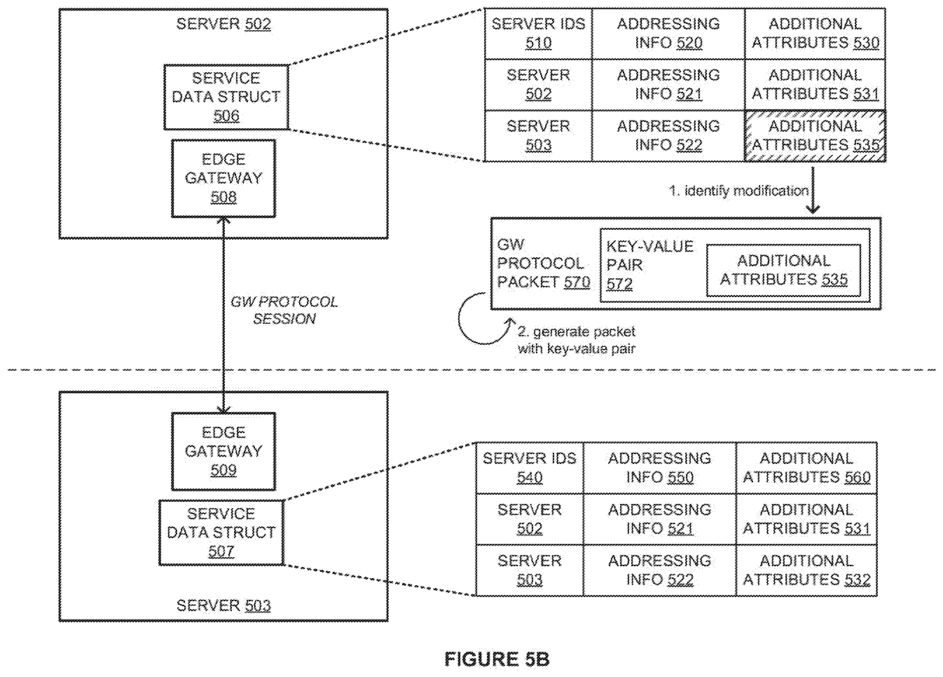

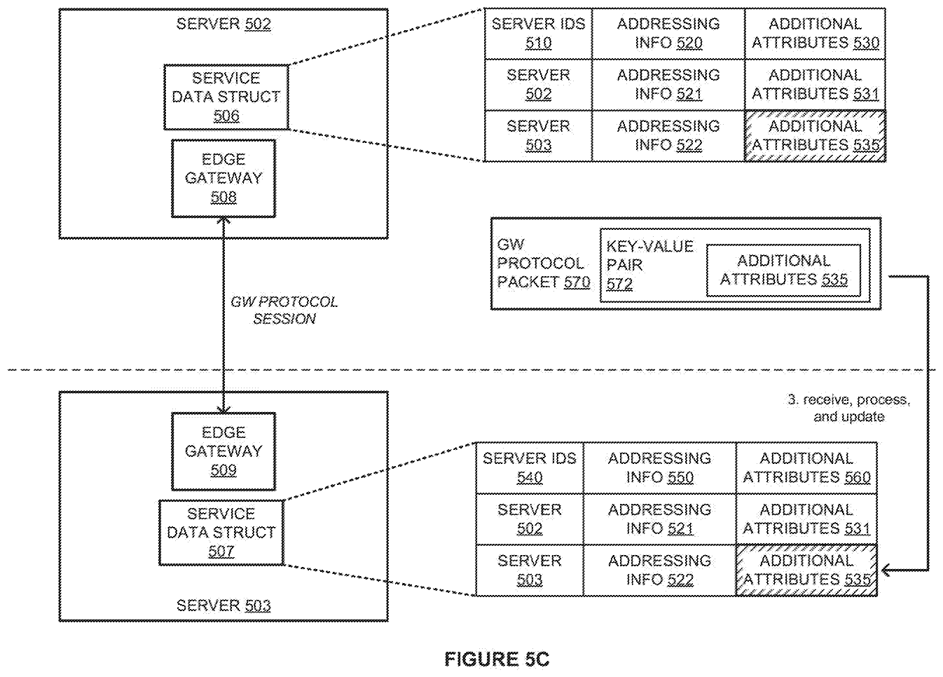

FIGS. 5A-5C illustrate an operational scenario of updating a service data structure according to an implementation. FIGS. 5A-5C include servers 502 and 503, which are representative of servers that operate in a computing environment, such as a fog computing environment. FIGS. 5A-5C further demonstrate an expanded example of service data structures 506-507, wherein service data structure 506 includes service identifiers (IDs) 510 with identifiers for servers 502-503, node address information 520 with addressing information 521-522, and additional attributes 530 with additional attributes 531-532. Additionally, service data structure 507 includes server IDs 540 with identifiers for servers 502-503, addressing information 550 with addressing information 521-522, and additional attributes 560 with additional attributes 531-532. Although demonstrated in the example of FIG. 5 using two servers in a computing environment, a computing environment may employ any number of servers. In at least one implementation, each of the servers may correspond to a fog server capable of hosting one or more fog nodes (virtual machines) that execute services as containers on the virtual nodes.

Referring first to FIG. 5A, servers 502-503 maintain service data structures 506-507, wherein the service data structures may maintain identifiers for computing servers in a fog computing environment, addressing information for at least one node in the fog computing environment, and service type information for services provided by the at least one fog node (represented as additional attributes 530 and 560). As an example, server 502 may execute a virtual node that provides a platform for one or more containers to provide various fog operations, such as data processing, for data obtained from one or more edge devices. For instance, a camera may be communicatively coupled to server 502 and containers executing thereon may provide image processing on data from the camera. Once processed, the containers may modify the functionality of the camera, may transfer data to a centralized data processing resource, or may provide any other similar operation. To facilitate the required operations, service data structures 506-507 may be used to identify addressing information for the various nodes of the computing environment, the load on the various nodes, or any other similar information. This information may be used to manage communications between the various services and nodes of the computing environment.

Turning to FIG. 5B, server 502 may identify, at step 1, a modification 502 to service data structure 506, wherein the modification may be triggered by an administrator associated with the computing environment, may be triggered based on a failover of a server in the computing environment, may be triggered by a load modification in server 502, or may be triggered in any other similar manner. In response to identifying the modification, server 502 may generate, at step 2, key-value pair 572 with additional attributes 535, and generate gateway packet 570 that includes key-value pair 572. Key-value pair 572 may comprise a new address family type capable of being included in metadata of a MP-BGP packet. Advantageously, rather than establishing a new communication protocol session, server 502 may use a previously established communication session for the packet.

Referring to FIG. 5C, once gateway protocol packet 570 is generated, server 502 may communicate the packet to server 503. As depicted, servers 502-503 may establish a gateway protocol session between edge gateways 508 and 509. Once established, gateway protocol packets, such as gateway protocol packet 570 may be communicated between the edge gateways to provide various routing functions for the computing environment. Here, once gateway protocol packet 570 is generated, the packet is communicated to server 503 where the packet is received, at step 3. Once received, server 503 may process the packet to identify key-value pair 572, and may update service data structure 507 based on the information in key-value pair 572. In the present implementation, based on the key-value pair, server 503 may replace additional attributes 532 with additional attributes 535. This permits server 503 to reflect the changes identified by another server in the computing environment and ensure that status and configuration information remains consistent across the servers of the computing environment.

Although demonstrated in the examples of FIGS. 4 and 5 as replacing data within the service data structures, modifications may include adding or removing data from the various data structures. As an example, server 502 of FIG. 5 may determine that a fog node is no longer executing in the computing environment. In response to identifying the execution status of the fog node, status information for the fog node may be removed from the local service data structure and an update may be generated for one or more other servers to remove the corresponding data for the fog node. In this manner, when a modification is identified at a first server, each of the other servers of the computing environment may be provided with the same update.

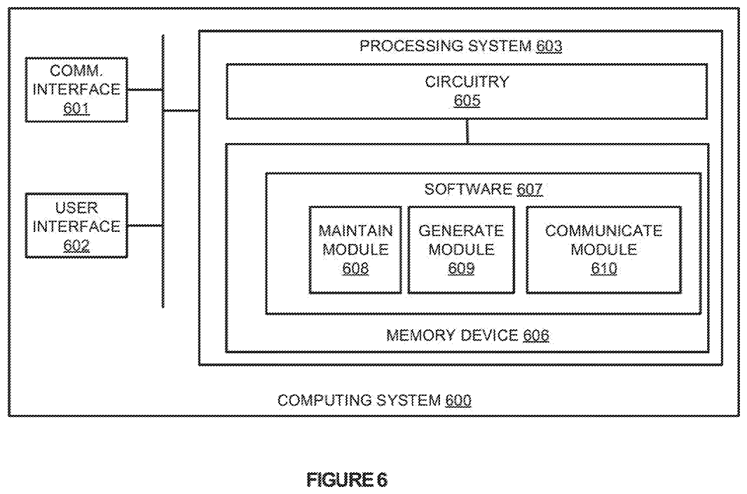

FIG. 6 illustrates a computing system 600 capable updating a service data structure according to an implementation. Computing system 600 is representative of any computing system or systems with which the various operational architectures, processes, scenarios, and sequences disclosed herein for a computing element may be implemented. Computing system 600 is an example of management service 150 and servers 101-103, although other examples may exist. Computing system 600 comprises communication interface 601, user interface 602, and processing system 603. Processing system 603 is linked to communication interface 601 and user interface 602. Processing system 603 includes processing circuitry 605 and memory device 606 that stores operating software 607. Computing system 600 may include other well-known components such as a battery and enclosure that are not shown for clarity.

Communication interface 601 comprises components that communicate over communication links, such as network cards, ports, radio frequency (RF), processing circuitry and software, or some other communication devices. Communication interface 601 may be configured to communicate over metallic, wireless, or optical links. Communication interface 601 may be configured to use Time Division Multiplex (TDM), Internet Protocol (IP), Ethernet, optical networking, wireless protocols, communication signaling, or some other communication format—including combinations thereof. In at least one implementation, communication interface 601 may be used to communicate with edge fog devices, other servers, and/or management services for a computing environment.

User interface 602 comprises components that interact with a user to receive user inputs and to present media and/or information. User interface 602 may include a speaker, microphone, buttons, lights, display screen, touch screen, touch pad, scroll wheel, communication port, or some other user input/output apparatus—including combinations thereof. User interface 602 may be omitted in some examples.

Processing circuitry 605 comprises microprocessor and other circuitry that retrieves and executes operating software 607 from memory device 606. Memory device 606 may include volatile and nonvolatile, removable and non-removable media implemented in any method or technology for storage of information, such as computer readable instructions, data structures, program modules, or other data. Memory device 606 may be implemented as a single storage device but may also be implemented across multiple storage devices or sub-systems. Memory device 606 may comprise additional elements, such as a controller to read operating software 607. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing circuitry 605 is typically mounted on a circuit board that may also hold memory device 606 and portions of communication interface 601 and user interface 602. Operating software 607 comprises computer programs, firmware, or some other form of machine-readable program instructions. Operating software 607 includes maintain module 608, generate module 609, and communicate module 610, although any number of software modules may provide a similar operation. Operating software 607 may further include an operating system, utilities, drivers, network interfaces, applications, or some other type of software. When executed by processing circuitry 605, operating software 607 directs processing system 603 to operate computing system 600 as described herein.

In one implementation, maintain module 608 directs processing system 603 to maintain a service data structure, wherein the service data structure maintains status information for services executing in a computing environment. In some implementations, the services may correspond to fog node services executed on fog nodes (virtual machines) operating in the computing environment. In some examples, the status information may include identifiers for the servers in the environment, addressing for the fog nodes executing on the servers, and service information for the services executing on the fog nodes, wherein the services may comprise containers in some examples. In at least one implementation the service information may include the type of service provided, the load on the services, or any other similar information related to the services.

While maintaining the service data structure, maintain module 608 may identify a modification to the data structure, wherein the modification may comprise a change to a value in the data structure, an addition of a container, node, or server to the data structure, a removal of a container, node, or server from the data structure, or some other similar modification to the data structure. As an example, when computing system 600 represents a server in a computing environment, computing system 600 may identify a modification to a load value associated with computing system 600, wherein the load value corresponds to a processing load generated by the nodes executing on computing system 600. This modification may be provided by a user associated with the computing environment, may be determined based on monitoring the processing load on the computing system, or may be determined in any other similar manner.

In response to identifying the modification to the service data structure, generate module 609 directs processing system 603 to generate a key-value pair representative of the modification and generate a gateway protocol packet that includes the key-value pair. Once generated, communicate module 610 may communicate the packet to another computing element in the computing environment. As an example, computing system 600 may establish a gateway protocol session with other servers operating in the computing environment. Once established, computing system 600 may communicate the gateway protocol packet with the key-value pair to one or more other servers in the computing environment, permitting the one or more other servers to update a local service data structure.

In some implementations, communicate module 610 may further be configured to obtain gateway protocol packets from one or more other computing elements (e.g., management systems, servers, and the like) and process the packets to determine any modifications to the service data structure. In at least one implementation, when a packet is received, maintain module 608 may parse the packet to determine if any key-value pairs are included in the packet, wherein the key-value pairs correspond to modifications of the service data structure. When a key-value pair is identified, maintain module 608 may determine where the new data is located in the data structure, and what data should be implemented in the data structure. Once identified, maintain module 608 may implement the modification in the service data structure.

Although demonstrated in the examples of FIGS. 1-6 as using a separate edge gateway for each server, an edge gateway may serve multiple servers in some implementations. Further, while demonstrated with the virtual nodes executing on the same computing element as the edge gateway, the edge gateway may execute on different computing elements than the virtual nodes. For example, one or more servers may execute fog nodes for a computing environment and communicate with another computing element that provides the edge gateway operations. This edge gateway may then communicate with other servers and/or management services operating in different physical locations.

Returning to the elements of FIG. 1, management service 150 and servers 101-103 may each comprise communication interfaces, network interfaces, processing systems, computer systems, microprocessors, storage systems, storage media, or some other processing devices or software systems, and can be distributed among multiple devices. Examples of management service 150 and servers 101-103 can include software such as an operating system, logs, databases, utilities, drivers, networking software, and other software stored on a computer-readable medium. Management service 150 and servers 101-103 may comprise, in some examples, one or more rack server computing systems, desktop computing systems, laptop computing systems, or any other computing system, including combinations thereof.

Communication between management service 150 and servers 101-103 may use metal, glass, optical, air, space, or some other material as the transport media. Communication between management service 150 and servers 101-103 may use various communication protocols, such as Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format, including combinations, improvements, or variations thereof. Communication between management service 150 and servers 101-103 may use direct links or can include intermediate networks, systems, or devices, and can include a logical network link transported over multiple physical links.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
in a first computing element, identifying a modification to a service data structure maintained by the first computing element, wherein the service data structure comprises service status information for a computing environment;
in the first computing element and in response to the modification, determining a key-value pair associated with the modification;
in the first computing element, generating a gateway protocol packet containing the key-value pair; and
in the first computing element, communicating the gateway protocol packet to a second computing element associated with the modification.

2. The method of claim 1, wherein the gateway protocol packet comprises a multiprotocol border gateway protocol (MP-BGP) packet.

3. The method of claim 2, wherein generating the gateway protocol packet containing the key-value pair comprises generating the gateway protocol packet containing the key-value pair as a new address family type.

4. The method of claim 1 further comprising:
in the second computing element, obtaining the gateway protocol packet;
in the second computing element, processing the gateway packet to identify the key-value pair;
in the second computing element, updating a service data structure maintained by the second computing element based on the key-value pair.

5. The method of claim 1, wherein the service data structure maintained by the first computing element comprises fog node information for fog nodes in the computing environment, and wherein the second computing element comprises a fog server.

6. The method of claim 1, wherein the service data structure comprises identifiers for at least one server in the computing environment, addressing information for at least one node executing on the at least one server, and service type information for services provided by the at least one node.

7. The method of claim 1, wherein the first computing element operates as a route reflector.

8. The method of claim 1, wherein the first computing element comprises a fog server and the second computing element comprises a fog server.

9. A computing element comprising:
one or more non-transitory computer readable storage media;
a processing system operatively couple to the one or more non-transitory computer readable storage media; and
program instructions stored on the one or more non-transitory computer readable storage media that, when read and executed by the processing system, direct the processing system to at least:
identify a modification to a service data structure maintained by the computing element, wherein the service data structure comprises service status information for a computing environment;
determine a key-value pair associated with the modification;
generate a gateway protocol packet containing the key-value pair; and
communicate the gateway protocol packet to a second computing element associated with the modification.

10. The computing element of claim 9, wherein the gateway protocol packet comprises a multiprotocol border gateway protocol (MP-BGP) packet.

11. The computing element of claim 10, wherein generating the gateway protocol packet containing the key-value pair comprises generating the gateway protocol packet containing the key-value pair as a new address family type.

12. The computing element of claim 9, wherein the service data structure maintained by the first computing element comprises fog node information for fog nodes in the computing environment, and wherein the second computing element comprises a fog server.

13. The computing element of claim 9, wherein the program instructions further direct the processing system to establish a gateway protocol session between the computing element and the second computing element.

14. The computing element of claim 9, wherein the service data structure comprises identifiers for at least one server in the computing environment, addressing information for at least one node executing on the at least one server, and service type information for services provided by the at least one node.

15. The computing element of claim 9, wherein the computing element comprises a route reflector.

16. The computing element of claim 9, wherein the computing element comprises a fog server and the second computing element comprises a fog server.

17. An apparatus comprising:
one or more non-transitory computer readable storage media; and
program instructions stored on the one or more non-transitory computer readable storage media that, when read and executed by a processing system, direct the processing system to at least:
identify a modification to a service data structure maintained by the computing element, wherein the service data structure comprises service status information for a computing environment;
determine a key-value pair associated with the modification;
generate a gateway protocol packet containing the key-value pair; and
communicate the gateway protocol packet to a second computing element associated with the modification.

18. The apparatus of claim 17, wherein the gateway protocol packet comprises a multiprotocol border gateway protocol (MP-BGP) packet.

19. The apparatus of claim 18, wherein generating the gateway protocol packet containing the key-value pair comprises generating the gateway protocol packet containing the key-value pair as a new address family type.

20. The apparatus of claim 18, wherein the program instructions further direct the processing system to:
obtain a second gateway protocol packet;
process the second gateway protocol packet to identify a second key-value pair; and
update the service data structure based on the key-value pair.
